(19) United States
(12) Patent Application Publication
(10) Pub. No.: US 2024/0042672 A1
(43) Pub. Date: Feb. 8, 2024

(54) TOOLING FOR DEFORMING A FIBROUS BLANK

(71) Applicant: SAFRAN AERO BOOSTERS, HERSTAL (BE)

(72) Inventors: Michel WLASOW WLASOWSKI, HERSTAL (BE); Hugues BOLSEE, HERSTAL (BE)

(21) Appl. No.: 18/363,449

(22) Filed: Aug. 1, 2023

(30) Foreign Application Priority Data
Aug. 4, 2022 (BE) 2022/5613

(51) Int. Cl. B29C 53/04; B29C 53/00

(52) U.S. Cl. CPC B29C 53/04; B29C 53/005; B29K 2105/06

(57) ABSTRACT

A tooling for deforming a fibrous blank includes at least a first and a second arch extending along a circumferential direction between a first end and a second end, the first ends of the arches being present in a first area and the second ends of the arches being present in a second area, the first end of at least one of the arches having a fixed position along the transverse direction and the second ends of the arches being able to move along the transverse direction, the first and the second arch being intended to be in contact with the surface of the fibrous blank.

### CROSS-REFERENCE TO RELATED APPLICATIONS

This application claims priority to Belgium Patent Application No. 2022/5613, filed Aug. 4, 2022, the entire content of which is incorporated herein by reference in its entirety.

### FIELD

The present invention relates to the manufacture of parts made of composite material by deformation of a fibrous blank. Particularly, but not exclusively, the invention relates to the manufacture of casings for aeronautical engines.

### BACKGROUND

The use of composite materials for the manufacture of aeronautical parts, for example for the casings of aeronautical engines, makes it possible to obtain resistant parts with mechanical performance equivalent or even higher than the mechanical performance of parts made of metal, while having a much lower mass.

It is known to produce composite material parts by draping on a surface of pre-impregnated fibrous structures to produce a fibrous blank. For reasons of production costs and repeatability, the draping can be carried out automatically, according to the automated fiber placement (AFP) technique. One example of a method for manufacturing a composite material part using the AFP method is for example described in document US 2020001504 A1.

For the production of composite material parts comprising a body of partial revolution and a flange, the angles between the body and the flange may be too narrow to allow the passage of the automated fiber placement deposition head. Thus, it is known to produce a fibrous blank by automated fiber placement with a more closed body, which makes it possible to increase the angle between the body and the flange, then to deploy the blank to straighten the flange and obtain the desired shape. Such a solution is explained in particular in document WO 2018/007756.

However, the current deployment of such blanks generates folds and wrinkles in the material, and creates unwanted tensions in the fibers and between the different layers of fibers. Furthermore, the orientations of the fibers as deposited can be altered, reducing the mechanical characteristics of the final part obtained from the fibrous blank.

### SUMMARY

An aspect of the present invention aims to overcome the aforementioned drawbacks. To this end, an aspect of the invention proposes a tooling for deforming a fibrous blank, including a base comprising a first area and a second area along a transverse direction, the tooling further comprising at least a first and a second arch extending along a circumferential direction between a first end and a second end around an axial direction perpendicular to the transverse direction and to the circumferential direction, the first ends of the arches being present in the first area of the base and the second ends of the arches being present in the second area of the base, the first end of at least one of the arches having a fixed position along the transverse direction and the second ends of the arches being able to move along the transverse direction in the second area, the first and the second arch being intended to be in contact with the surface of the fibrous blank.

The deformation tooling according to an aspect of the invention makes it possible to easily support the weight of the fibrous blank thanks to the arches. Furthermore, such a tooling allows controlled deformation of the fibrous blank by using arches, one end of which is fixed with respect to the transverse direction while the other end is movable with respect to the transverse direction. Thus, the occurrence of folds or wrinkles in the material is limited and the occurrence of tensions in the fibers due to unmastered deformation of the fibrous blank is limited. Finally, the use of arches makes it possible to preserve the axisymmetric shape of the blank during the deformation and to avoid the formation of folds or wrinkles along the transverse direction.

According to one particular embodiment of the invention, the first end and the second end of one of the arches are able to move along the axial direction so as to adjust the distance between the arches.

The mobility of an arch along an axial direction perpendicular to the transverse direction allows better mastering of the deformation of the fibrous blank, and ensures that the fibrous blank remains taut between the arches without forming folds or wrinkles along the axial direction.

According to another particular embodiment of the invention, the ends of the arches belong to the same plane extending along the transverse direction and the axial direction.

According to another particular embodiment of the invention, the tooling further comprises one or more strip(s) connecting the arches along the axial direction, the strips being intended to match the profile of the fibrous blank.

Thus, it is ensured that the fibrous blank is properly held between the arches, and the risk of sagging of the fibrous blank between the arches is limited. Furthermore, as the strips match the profile of the fibrous blank, they make it possible to preserve the curvilinear lengths of the blank along the axial direction during the deformation of the blank.

According to another particular embodiment of the invention, the tooling further comprises a skin connecting the arches along the axial direction, the skin being intended to match the profile of the fibrous blank. In an embodiment, the skin is made of silicone or rubber.

This variant also ensures that the fibrous blank is properly held between the arches, and the risk of sagging of the fibrous blank between the arches is limited. Furthermore, as the skin matches the profile of the fibrous blank, it makes it possible to preserve the curvilinear lengths of the blank along the axial direction during the deformation of the blank.

An aspect of the invention also proposes a deformation assembly comprising the deformation tooling as described above and a fibrous blank intended to form the fibrous reinforcement of a composite material part, the blank comprising a body of partial revolution extending along the circumferential direction around the axial direction, the body extending along the axial direction between a first and a second circumferential edge, the fibrous blank being mounted on the deformation tooling so that the first and the second arch respectively match the first and the second circumferential edge of the body of the fibrous blank.

As the circumferential edges of the body of the fibrous blank match the arches, it is ensured that the length of the circumferential edges is preserved during the deformation of the fibrous blank on the deformation tooling. Thus, tensions are not generated in the fibers of the fibrous blank.

Another aspect of the invention further proposes a method for deforming a fibrous blank to obtain a fibrous preform intended to form the fibrous reinforcement of a composite material part, comprising:
the arrangement of a fibrous blank on a deformation tooling so as to obtain the deformation assembly as described above,
the displacement along the transverse direction of the second ends of the arches so as to deform the fibrous blank to obtain a fibrous preform, the body of the fibrous preform having a shape of partial revolution extending along the circumferential direction around the axial direction, the body of the fibrous preform extending along the axial direction between a first and a second circumferential edge having respectively the same length along the circumferential direction as the first and the second circumferential edge of the body of the fibrous blank.

Such a method makes it possible to deform the fibrous blank into a fibrous preform while preserving the circumferential lengths, the axial curvilinear lengths and the axisymmetric shape, so as not to form folds and not to create tensions in the fibers.

According to a particular embodiment of the invention, the fibrous blank comprises a flange extending from the second circumferential edge of the body of the blank along a direction of extension, the fibrous preform comprising a flange extending from the second circumferential edge of the body of the preform along a direction of expansion different from the direction of extension.

The deformation tooling described above is particularly adapted to obtain a fibrous preform with a flange, particularly when the angle between the flange and the body is narrow. Indeed, the manufacture of a fibrous blank comprising a flange having a narrow angle with the body is difficult, particularly with the automated fiber placement method because the narrow angle does not allow the passage of a deposition head. It is thus desirable to produce a fibrous blank with a greater angle but having a more curved body shape, then to deploy the fibrous blank to obtain the desired body shape and thus fold down the flange at the desired angle.

Thus, an aspect of the invention relates to a method for manufacturing a fibrous preform intended to form the fibrous reinforcement of a composite material part, the method comprising:
the manufacture of a fibrous blank by automated fiber placement on a surface, the blank comprising a body of partial revolution extending along the circumferential direction around the axial direction, the body extending along the axial direction between a first and a second circumferential edge, the blank further comprising a flange extending from the second circumferential edge of the body along a direction of extension,
the impregnation of the fibrous blank with a resin,
the deformation of the fibrous blank to obtain a fibrous preform by implementation of the method described above.

### BRIEF DESCRIPTION OF THE DRAWINGS

FIG. 1 is a schematic perspective view of a fibrous blank intended to be deformed.

FIG. 2 is a schematic perspective view of a fibrous preform obtained by deployment of the fibrous blank of FIG. 1.

FIG. 3 is a diagram schematically representing the radii of the blank of FIG. 1 and of the preform of FIG. 2 along their axis of revolution.

FIG. 4 is a schematic perspective view of the deformation tooling according to an embodiment of the invention.

FIG. 5 is a schematic perspective view of the deformation tooling of FIG. 4 on which the fibrous blank of FIG. 1 is mounted.

FIG. 6 is a schematic perspective view of the deformation tooling of FIG. 4 after deployment of the fibrous blank of FIG. 1 to obtain the fibrous preform of FIG. 2.

### DETAILED DESCRIPTION

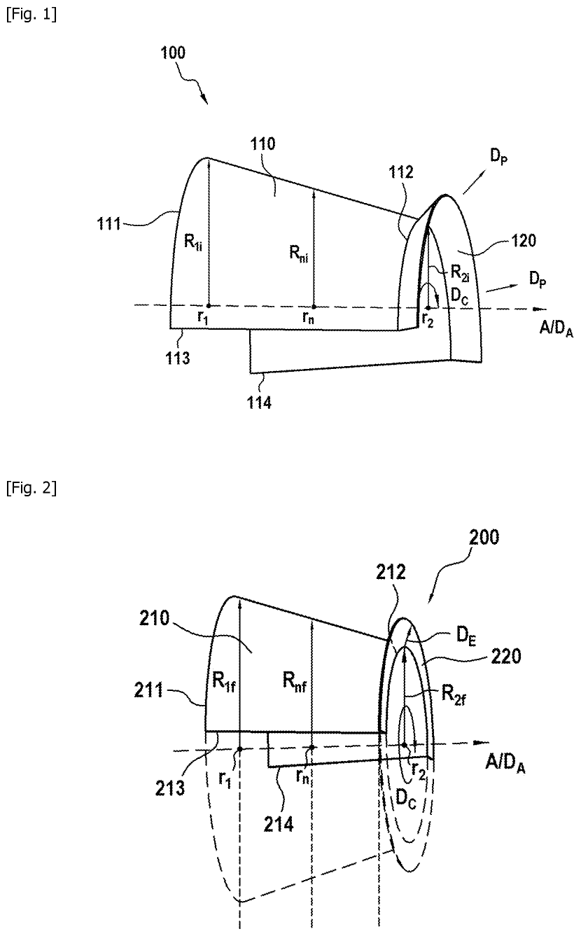

FIG. 1 illustrates a fibrous blank 100 intended to be deformed or deployed to obtain a fibrous preform 200.

The fibrous blank 100 comprises at least one body 110. The body 110 of the fibrous blank 100 is a volume of partial revolution whose axis of revolution A is directed along an axial direction D_{A}. The body 110 of the fibrous blank 100 partially extends around its axis of revolution A along a circumferential direction D_{C}. The circumferential direction D_{C} extends circularly in a plane perpendicular to the axial direction D_{A}. The body 110 of the fibrous blank 100 can have a frustoconical or tubular shape, or any axisymmetric profile.

The body 110 of the fibrous blank 100 extends along the axial direction D_{A} between a first circumferential edge 111 and a second circumferential edge 112. The body 110 of the fibrous blank 100 extends along the circumferential direction D_{C} between a first axial edge 113 and a second axial edge 114.

The first circumferential edge 111 of the body 110 extends around the axial direction D_{A} along a first initial radius R₁ᵢ. The second circumferential edge 112 of the body 110 extends around the axial direction D_{A} along a second initial radius R₂ᵢ. The first initial radius R₁ᵢ and the second initial radius R₂ᵢ can be of different value, as illustrated in FIG. 1. It will be appreciated that there is no departure from the scope of the invention if the first initial radius R₁ᵢ and the second initial radius R₂ᵢ have the same value.

The initial radius Rₙᵢ of the body 110 can vary between the first circumferential edge 111 and the second circumferential edge 112. For example, if the body 110 has a frustoconical shape as illustrated in FIG. 1, the initial radius Rₙᵢ of the body 110 decreases steadily from the first initial radius R₁ᵢ to the second initial radius R₂ᵢ.

In each plane perpendicular to the axial direction D_{A}, the initial radius R₁ᵢ, Rₙᵢ, R₂ᵢ is defined as the distance between the axial direction D_{A} and the arc of a circle formed by the body 110, and corresponds respectively to a position r₁, rₙ, r₂ of the axial direction D_{A}, as illustrated in FIG. 1.

The arc of a circle formed by the body 110 of the fibrous blank 100 in each plane perpendicular to the axial direction D_{A} is intercepted by an initial angle θᵢ. In the example illustrated in FIG. 1, the value of the initial angle θᵢ is 225°, that is to say the body 110 of the fibrous blank 100 extends over 225° around the axial direction D_{A}. If the body 110 of the fibrous blank 100 had the shape of a half-shell, the value of the initial angle would be 180°.

The fibrous blank 100 can further comprise a flange 120. The flange 120 extends from the first or the second circumferential edge 111 or 112 of the fibrous blank 100. The flange 120 of the blank 100 has an annular or frustoconical shape with an axis of partial revolution A directed along the axial direction D_{A}. The flange 120 of the blank 100 extends from the body 110 along a direction of extension D_{P}.

In an embodiment, the entire fibrous blank 100 is a volume of partial revolution with an axis A directed along the axial direction D_{A}. The direction of extension D_{P} is defined for each point of the junction between the body 110 and the flange 120. The directions of extension D_{P} at two different points of the junction can be oriented differently. The directions of extension D_{P} defined for each point of the junction between the body 110 and the flange 120 can be secant at a single point belonging to the axis of revolution A of the fibrous blank 100.

The fibrous blank 100 is in an embodiment produced by draping of fibrous structures on a surface, according to the well-known automated fiber placement (AFP) method. The draped fibrous structures can be dry or impregnated. The draped fibrous structures can for example be impregnated with an aqueous suspension comprising matrix precursor particles, be impregnated with a thermosetting polymer or be impregnated with a thermoplastic polymer, as described in document US 2020001504 A1. More generally, the fibrous structures can be impregnated with a resin. Chemical or thermal treatments can then be carried out on the blank depending on the nature of the draped fibrous structures.

The fibrous blank 100 can be produced from ceramic fibers or carbon fibers, or from a mixture of the two. Particularly, the fibrous blank 100 can be produced from fibers consisting of the following materials: alumina, mullite, silica, an aluminosilicate, borosilicate, silicon carbide, carbon, or a mixture of several of these materials. The fibrous blank 100 can comprise any type of glass fibers.

The fibrous blank 100 is intended to be deployed to obtain a fibrous preform 200 as illustrated in FIG. 2. In order not to generate unwanted stresses or tensions in the fibers of the fibrous preform 200, the deformation of the fibrous blank 100 into fibrous preform 200 is made so as to preserve the lengths along the circumferential direction D_{C} and along the axial direction D_{A}, and so as to preserve the axisymmetry.

The fibrous preform 200 thus comprises a body 210 obtained by deployment of the body 110 of the fibrous blank 100. The body 210 of the fibrous preform 200 is therefore a volume of partial revolution whose axis of revolution A is directed along the axial direction D_{A}. The body 210 of the fibrous preform 200 extends partially around its axis of revolution A along the circumferential direction D_{C}.

The body 210 of the fibrous preform 200 extends along the axial direction D_{A} between a first circumferential edge 211, corresponding to the first circumferential edge 111 of the fibrous blank 100, and a second circumferential edge 212, corresponding to the second circumferential edge 112 of the fibrous blank 100. The body 210 of the fibrous preform 200 extends along the circumferential direction D_{C} between a first axial edge 213, corresponding to the first axial edge 113 of the fibrous blank 100, and a second axial edge 214, corresponding to the second axial edge 114 of the fibrous blank 100.

The fibrous preform 200 can further comprise a flange 220 corresponding to the flange 120 of the fibrous blank 100. The flange 220 of the fibrous preform 200 extends from the first or the second circumferential edge 211 or 212 of the fibrous preform 200 along a direction of expansion DE. Due to the deployment of the body 110 of the blank 100 in a body 210 of the preform 200, the inclination of the flange 120 of the blank 100 changes. Thus, the angle formed between the body 210 and the flange 220 of the fibrous preform 200 is smaller than the angle formed between the body 110 and the flange 120 of the fibrous blank 100.

The first circumferential edge 211 of the body 210 of the preform 200 extends around the axial direction D_{A} along a first final radius R_{1f}. The second circumferential edge 212 of the body 210 extends around the axial direction D_{A} along a second final radius R_{2f}. Each final radius R_{nf} of the body 210 can vary between the first circumferential edge 211 and the second circumferential edge 212. In each plane perpendicular to the axial direction D_{A}, the final radius R_{1f}, R_{nf}, R_{2f} is defined as the distance between the axial direction D_{A} and the arc of a circle formed by the body 210. The final radii R_{1f}, R_{nf}, R_{2f} can respectively correspond to one of the positions r₁, rₙ, r₂ of the axial direction D_{A}, as illustrated in FIG. 2. In the example illustrated in the figures, in which the fibrous blank 100 is deployed to obtain the fibrous preform 200, each final radius R_{1f}, R_{nf}, R_{2f} is greater than the initial radius R₁ᵢ, Rₙᵢ, R₂ᵢ for the same given position r₁, rₙ, r₂.

The arc of a circle formed by the body 210 of the fibrous preform 200 in each plane perpendicular to the axial direction D_{A} is intercepted by a final angle θ_{f} smaller than the initial angle θᵢ. In the example illustrated in FIG. 2, the value of the final angle θ_{f} is 180°. The transformation of the fibrous blank into fibrous preform can be characterized by a transformation ratio which corresponds to the ratio of the final angle θ_{f} by the initial angle θᵢ. In an embodiment, the transformation ratio is comprised between 0.6 and 0.8. In the example illustrated in FIGS. 1 and 2, the transformation ratio corresponds to the ratio of 180° by 225°, i.e. 0.8.

As the lengths along the circumferential direction D_{C} of the body 110 of the fibrous blank 100 are preserved during its deformation into fibrous preform 200, the transformation ratio also corresponds to the ratio of the second initial radius R₂ᵢ by the second final radius R_{2f}.

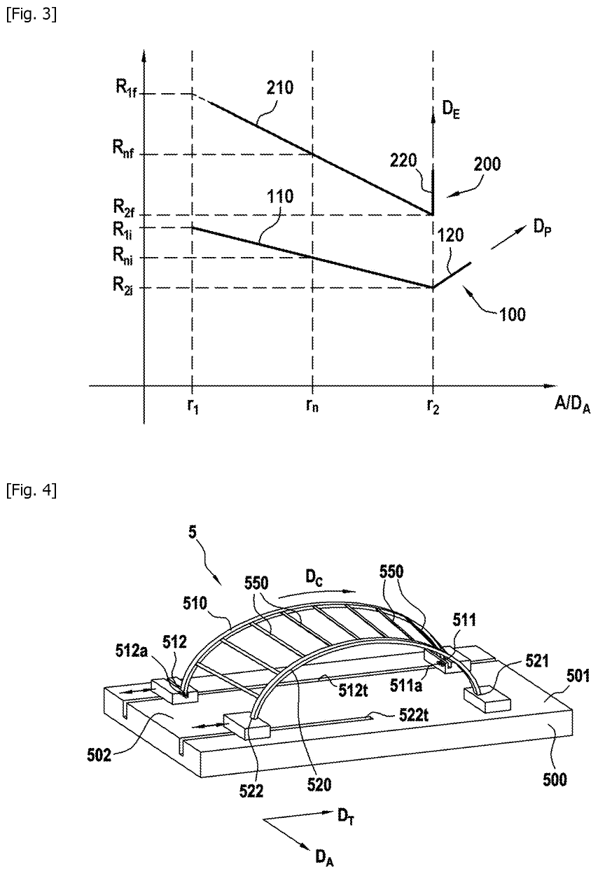

FIG. 3 is a schematic diagram illustrating the initial radii R₁ᵢ, Rₙᵢ, R₂ᵢ of the fibrous blank 100 and the final radii R_{1f}, R_{nf}, R_{2f} of the fibrous preform 200 for different positions r₁, rₙ, r₂ along the axial direction D_{A}.

It can be seen in FIG. 3 that the slope of the body 110 of the fibrous blank 100 with respect to the axial direction D_{A} can be gentler than the slope of the body 210 of the fibrous preform 200 with respect to the axial direction D_{A}. Thus, the projection on the axial direction D_{A} of the body 210 of the fibrous preform 200 can be smaller than the projection on the axial direction D_{A} of the body 110 of the fibrous blank 100. As a result, the first final radius R_{1f} of the first circumferential edge 211 of body 210 of the fibrous preform 200 may not be quite at the position r₁ along the axial direction D_{A}, as illustrated in FIG. 3.

In order to carry out the deformation of the fibrous blank 100 into fibrous preform 200, if the fibrous blank 100 is impregnated with a resin, the fibrous blank 100 is heated to become more malleable, and thus be able to deform.

The deployment of the blank 100 is guided and carried out gradually, in order to limit the risk of damage. Furthermore, its deployment complies with the lengths along the circumferential direction D_{C} and along the axial direction D_{A}, without stretching nor compacting the material constituting the fibrous blank 100, so as not to generate unwanted stresses in the fibers of the blank 100.

In order to carry out this step of deforming the fibrous blank 100, a deformation tooling is used, an example of which is illustrated in FIG. 4.

The example of a deformation tooling 5 illustrated in FIG. 4 comprises a base 500 extending along the axial direction D_{A} and along a transverse direction D_{T} perpendicular to the axial direction D_{A}.

The deformation tooling 5 comprises at least a first arch 510 and a second arch 520, extending along the circumferential direction D_{C}. The first arch 510 extends along the circumferential direction D_{C} between a first end 511 and a second end 512. The second arch 520 extends along the circumferential direction D_{C} between a first end 521 and a second end 522. The first end 511 of the first arch 510 and the first end 521 of the second arch 520 are disposed in a first area 501 of the base 500, and the second end 512 of the first arch 510 and the second end 522 of the second arch 520 are disposed in a second area 502 of the base 500 opposite to the first area 501 of the base 500 along the transverse direction D_{T}. The ends 511, 512, 521, 522 of the arches 510 and 520 belong to the same plane extending along the axial direction D_{A} and along the transverse direction D_{T}.

The arches 510, 520 can be made of metal. The arches can also be made of plastic or carbon fiber.

The first arch 510 is intended to match the first circumferential edge 111 of the body 110 of the fibrous blank 100. The second arch 520 is intended to match the second circumferential edge 112 of the body 110 of the fibrous blank 100. Thus, the spacing between the first arch 510 and the second arch 520 along the axial direction D_{A} corresponds to the spacing between the first circumferential edge 111 and the second circumferential edge 112 of the fibrous blank 100.

When the circumferential edges 111 and 112 of the body 110 are positioned on the arches 510 and 520 of the tooling 5, there is no relative displacement between the circumferential edge 111 or 112 of the body 110 and the arch 510 or 520 on which it rests. Thus, it is ensured that the length of the circumferential edges 111 and 112 is preserved during the deformation of the fibrous blank 100 into fibrous preform 200, that the length of the first circumferential edge 211 of the fibrous preform 200 will be identical to the length of the first circumferential edge 111 of the fibrous blank 100 and that the length of the second circumferential edge 212 of the fibrous preform 200 will be identical to the length of the second circumferential edge 112 of the fibrous blank 100. By maintaining contact between the circumferential edges 111 and 112 of the body 110 of the blank 100 and the arches 510 and 520 of the tooling 5 during the transformation, it is also ensured that wrinkles or folds are not created in the material of the fibrous blank 100 during its deformation into fibrous preform 200.

The first end 521 of the second arch 520 has a fixed position along the transverse direction D_{T}. The first end 511 of the first arch 510 can be movable along the transverse direction D_{T}. The second end 512 of the first arch 510 and the second end 522 of the second arch 520 are movable along the transverse direction D_{T}. The movement along the transverse direction D_{T} of the second ends 512 and 522 of the arches 510 and 520 and possibly of the first end 511 of the first arch 510 can be achieved thanks to grooves 512t and 522t present in the base 500. The second ends 512 and 522 of the arches 510 and 520 can slide in the grooves 512t and 522t present in the base 500. The first end 511 of the first arch 510 can slide along the transverse direction D_{T} in a groove present in the base 500. The first end 511 of the first arch 510 can slide in the same groove 512t as the second end 512 of the first arch 510. The grooves 512t and 522t extend along the transverse direction D_{T}. More particularly, the second end 512 of the first arch 510 can slide along the transverse direction D_{T} in the first groove 512t present in the base 500, and the second end 522 of the second arch 520 can slide along the transverse direction D_{T} in the second groove 522t present in the base 500. The second ends 512 and 522 of the arches 510 and 520 slide in the second area 502 of the base 500. The first end 511 of the first arch 510 slides in the first area 501 of the base 500.

The deformation tooling 5 can comprise a transverse actuation system (not represented) allowing the displacement of the second ends 512 and 522 of the arches 510 and 520 in the grooves 512t and 522t along the transverse direction D_{T}. This transverse actuation system makes it possible to control the speed of displacement of the second ends 512 and 522 of the arches 510 and 520 in the grooves 512t and 522t along the transverse direction D_{T}. This transverse actuation system makes it possible to synchronize the movement of the first end 511 and of the second end 512 of the first arch 510 with the movement of the second end 522 of the second arch 520. Thus, the deployment of the fibrous blank 100 in fibrous preform 200 can be carried out in a controlled and mastered manner, avoiding deforming the fibers or generating folds in the material.

The transverse actuation system can be produced with a pulley system, a stepper motor system or a gear system which allows the synchronization of the movement of the ends 511, 512 and 522 of the arches 510 and 520. The transverse actuation system can be actuated by an electric motor. The transverse actuation system can be mechanically actuated by hand.

The first end 521 and the second end 522 of the second arch 520 have a fixed position along the axial direction D_{A}. The first end 511 and the second end 512 of the first arch 510 can be movable along the axial direction D_{A}. It will be appreciated that there is no departure from the scope of the invention if it is the first end 511 and the second end 512 of the first arch 510 that have a fixed position along the axial direction D_{A}, and the first end 521 and the second end 522 of the second arch 520 which are movable along the axial direction D_{A}. Indeed, as illustrated in FIG. 3, the body 110 of the fibrous blank 100 may have a projected length along the axial direction D_{A} that is different from the projected length along the axial direction D_{A} of the body 210 of the fibrous preform 200. Thus, in order to accompany this variation in length projected along the axial direction D_{A}, it is desirable that the ends of the first or second arch are movable along the axial direction D_{A}, in order to reduce the risk of wrinkles or folds in the material, and to limit the generation of stresses or tensions in the fibers.

In order to achieve the displacement of the ends 521 and 522 of the arch 520 along the axial direction D_{A}, the ends 521 and 522 can be connected to a block present in contact with the base 500, as illustrated in FIG. 4. The complete block can be movable along the transverse direction D_{T} if the arch end to which it belongs is movable along the transverse direction D_{T}. In this configuration, part of the complete block can slide in one of the grooves 512t of the base 500. The block further comprises a translation device 511a, 512a for moving the arch along the axial direction D_{A}. This translation device 511a, 512a can comprise one or more grooves in which the arch can slide. This translation device 511a, 512a can comprise one or more casters fixed to the arch 510 allowing it to move on the block along the axial direction D_{A}.

The deformation tooling 5 can comprise an axial actuation system (not represented) allowing the actuation of the translation device 511a, 512a of the arch 510. The axial actuation system thus makes it possible to move the arch 510 along the axial direction D_{A}. This axial actuation system makes it possible to control the speed of displacement of the first and second ends 511, 521 of an arch 510 along the transverse direction D_{A}. This axial actuation system makes it possible to synchronize the movement of the first and second ends 511, 521 of an arch 510 along the transverse direction D_{A}. In an embodiment, the transverse actuation system and the axial actuation system are coordinated, in order to ensure deployment of the fibrous blank 100 in fibrous preform 200 controlled both in the transverse direction D_{T} and in the axial direction D_{A}.

The axial actuation system can be produced with a pulley system, a stepper motor system or a gear system. The axial actuation system can be actuated by an electric motor. The axial actuation system can be mechanically actuated by hand.

The axial actuation system and the transverse actuation system are synchronized to allow controlled deformation of the fibrous blank 100 into fibrous preform 200.

In order to improve the rigidity of the arches 510 and 520 and the behavior of the fibrous blank 100 during its deformation into fibrous preform 200, the deformation tooling 5 can comprise one or more strips 550 connecting the arches 510 and 520. The strip(s) 550 are made of a semi-rigid material. The strips 550 can be made of metal or composite material. In an embodiment, for better holding of the fibrous blank 100 during its deformation, the strips 550 are evenly spaced along the arches 510 and 520.

When the fibrous blank 100 is mounted on the deformation tooling 5, the strip(s) 550 match(es) the shape of the fibrous blank 100. When the body 110 of the fibrous blank 100 is positioned on the strip(s) 550 of the tooling 5, there is no relative displacement between the strips 550 and the portions of the body 110 in contact with the strips 550. Thus, it is ensured that the curvilinear lengths of the body 110 extending along the axial direction D_{A} in contact with the strips 550 are preserved during the deformation of the fibrous blank 100 into fibrous preform 200. Thus, the deformation of the fibrous blank 100 is very precisely accompanied, further limiting the occurrence of wrinkles or folds in the material of the fibrous blank 100 during its deformation into fibrous preform 200 both in the axial D_{A} and circumferential D_{C} directions.

According to one variant not represented in the figures, the deformation tooling can comprise a skin connecting the arches 510 and 520. The skin can be made of silicone or rubber. When the fibrous blank 100 is mounted on the deformation tooling, the skin matches the shape of the fibrous blank 100. When the body 110 of the fibrous blank 100 is positioned on the skin of the tooling, there is no relative displacement between the skin and the portions of the body 110 in contact with the skin. Thus, it is ensured that the curvilinear lengths of the body 110 extending along the axial direction D_{A} in contact with the skin are preserved during the deformation of the fibrous blank 100 into fibrous preform 200. Thus, the deformation of the fibrous blank 100 is very precisely accompanied, further limiting the occurrence of wrinkles or folds in the material of the fibrous blank 100 during its deformation into fibrous preform 200 both in the axial D_{A} and circumferential D_{C} directions.

The deformation tooling 5 can also comprise one or more intermediate arches (not present in FIG. 4), of the same nature as the first and second arches 510 and 520, disposed between the first arch 510 and the second arch 520. These intermediate arches extend between a first end and a second end. The first end of the intermediate arch(es) is located in the first area 501 of the base 500, and the second end of the intermediate arch(es) is located in the second area 502 of the base 500. The first end of the intermediate arch(es) is present between the first ends 511 and 521 of the first and second arches 510 and 520. The first end of the intermediate arch(es) is in an embodiment movable along the transverse direction D_{T}, and movable along the axial direction D_{A}. The second end of the intermediate arch(es) is present between the second ends 512 and 522 of the first and second arches 510 and 520. The second end of the intermediate arch(es) is movable along the transverse direction D_{T}, and can be movable along the axial direction D_{A}.

These intermediate arches are particularly useful in the case where the fibrous blank 100 has a significant length along the axial direction D_{A}, in order to ensure better holding of the fibrous blank 100 and to avoid sagging in its center. In this configuration, these intermediate arches also ensure more accurate guiding of the deformation of the fibrous blank 100 in fibrous preform 200.

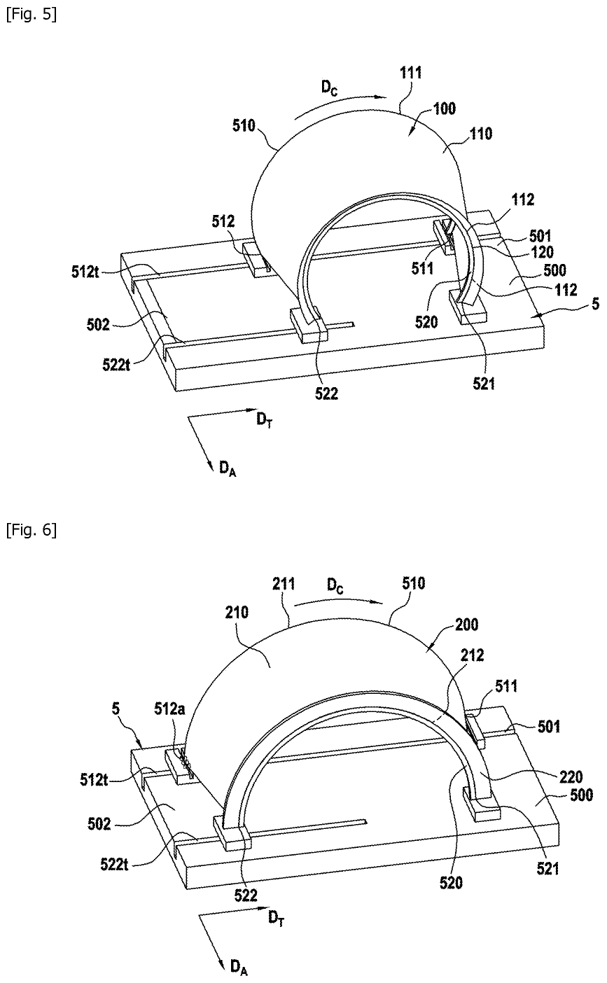

If the fibrous blank 100 is impregnated with resin, in order to be deformed, the latter is in an embodiment heated beforehand in order to become malleable. Then, the malleable fibrous blank 100 is disposed on the deformation tooling 5, as illustrated in FIG. 5. In order to properly position the fibrous blank 100 on the deformation tooling 5, gravity can be used. In order to properly position the fibrous blank 100 on the deformation tooling 5, it is also possible to use positioning pins, or a visual positioning device, for example a laser device.

FIG. 5 illustrates the positioning of the fibrous blank 100 on the deformation tooling 5 of FIG. 4. The second ends 512 and 522 of the first and second arches 510 and 520 are positioned close to the first ends 511 and 521 of the first and second arches 510 and 520 in order to be adapted to the shape of the body 110 of the fibrous blank 100. Thus, the first arch 510 extends along the circumferential direction D_{C} along the first initial radius R₁ᵢ, and the second arch 520 extends along the circumferential direction D_{C} along the second initial radius R₂ᵢ. The arches 510 and 520 of the deformation tooling 5 are then in the initial position.

The first circumferential edge 111 of the body 110 of the fibrous blank 100 is disposed in contact with the first arch 510 of the tooling 5, and the second circumferential edge 112 of the body 110 of the fibrous blank 100 is disposed in contact with the second arch 520 of the tooling 5. If the tooling 5 comprises one or more strips 550, the profile of the body 110 of the fibrous blank 100 is positioned in contact with the strip(s) 550.

When the fibrous blank 100 is suitably positioned on the deformation tooling 5, the second ends 512 and 522 of the first and second arches 510 and 520 move along the transverse direction D_{T} opposite to the first ends 511 and 521 of the first and second arches 510 and 520, in order to deploy the fibrous blank 100. In an embodiment, the first end 511 of the first arch 510 also moves along the transverse direction D_{T} opposite to the second end 512 of the first arch 510. The second ends 512 and 522 of the first and second arches 510 and 520 and the first end 511 of the first arch 510 move along the transverse direction D_{T} until the first arch 510 extends along the circumferential direction D_{C} along the first final radius R_{1f}, and the second arch 520 extends along the circumferential direction D_{C} along the second final radius R_{2f}, as illustrated in FIG. 6. If necessary, the ends of the first or of the second arch 510 or 520 move along the axial direction D_{A} during the displacement of the second ends 512 and 522 of the first and second arches 510 and 520 along the transverse direction D_{T} in order to adapt to the deployment of the blank without forming folds or tensions in the material. The arches 510 and 520 of the deformation tooling 5 are then in their final position. The deformation tooling 5 therefore comprises arches 510 and 520 movable between at least one initial position and one final position. The initial position and the final position of the arches 510 and 520 of the tooling 5 comply with the transformation ratio described above.

Thus, by using the deformation tooling as described above, it is ensured that the curvilinear lengths along the circumferential direction D_{C} and along the axial direction D_{A} are preserved, and that the axisymetry is preserved. Consequently, the inter-layer tensions in the fibers are minimized during the deployment, by limiting the occurrence of folds or wrinkles, which could affect the quality of the material of the final part obtained from the fibrous preform 200. Furthermore, the angles of the fibrous strips deposited by automated fiber placement are preserved.

As illustrated in FIG. 6, the deployment of the body 110 of the fibrous blank 100 causes a straightening of the flange 120 of the fibrous blank, so that the flange 220 of the fibrous preform 200 extends along a direction of expansion DE different from the initial direction of extension D_{P}. The desired fibrous preform 200 is therefore obtained.

The fibrous preform 200 is then infiltrated or treated to form a matrix inside the porosities of the fibrous preform 200, and thus obtain a composite material part whose fibrous reinforcement is formed by the fibrous preform 200. The fibrous preform obtained by deformation as described above can produce the fibrous reinforcement of a part made of ceramic-matrix composite (CMC) or organic-matrix composite (OMC) material. Particularly, the composite material part obtained from the fibrous preform can be intended to be part of an aeronautical engine casing.

In the example described above, the deformation tooling 5 is used for the deployment of a fibrous blank. It will be appreciated that there is no departure from the scope of the invention if the deformation tooling as described above is used to close a fibrous blank, that is to say the initial radii of the fibrous blank are reduced to obtain a fibrous preform with final radii smaller than the initial radii.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

It will be appreciated that the various embodiments and aspects of the inventions described previously are combinable according to any technically permissible combinations.

1. A tooling for deforming a fibrous blank including a base comprising a first area and a second area along a transverse direction, the tooling further comprising at least a first and a second arch extending along a circumferential direction between a first end and a second end around an axial direction perpendicular to the transverse direction and to the circumferential direction, the first ends of the arches being present in the first area of the base and the second ends of the arches being present in the second area of the base, the first end of at least one of the arches having a fixed position along the transverse direction and the second ends of the arches being adapted to move along the transverse direction in the second area, the first and the second arch being intended to be in contact with the surface of the fibrous blank.

2. The deformation tooling according to claim 1, wherein the first end and the second end of one of the arches are adapted to move along the axial direction so as to adjust the distance between the arches.

3. The deformation tooling according to claim 1, wherein the ends of the arches belong to a same plane extending along the transverse direction and the axial direction.

4. The deformation tooling according to claim 1, the tooling further comprising one or more strips connecting the arches along the axial direction, said one or more strips being intended to match the profile of the fibrous blank.

5. The deformation tooling according to claim 1, the tooling further comprising a skin connecting the arches along the axial direction, the skin being intended to match the profile of the fibrous blank.

6. A deformation assembly comprising the deformation tooling according to claim 1 and a fibrous blank intended to form the fibrous reinforcement of a composite material part, said fibrous blank comprising a body of partial revolution extending along the circumferential direction around the axial direction, said body extending along the axial direction between a first and a second circumferential edge, the fibrous blank being mounted on the deformation tooling so that the first and the second arch respectively match the first and the second circumferential edge of the body of the fibrous blank.

7. A method for deforming a fibrous blank to obtain a fibrous preform intended to form the fibrous reinforcement of a composite material part, the method comprising:
arranging a fibrous blank on a deformation tooling so as to obtain the deformation assembly according to claim 6, and
displacing along the transverse direction of the second ends of the arches so as to deform the fibrous blank to obtain a fibrous preform, the body of the fibrous preform having a shape of partial revolution extending along the circumferential direction around the axial direction, said body of the fibrous preform extending along the axial direction between a first and a second circumferential edge having respectively the same length along the circumferential direction as the first and the second circumferential edge of the body of the fibrous blank.

8. The deformation method according to claim 7, wherein the fibrous blank comprises a flange extending from the second circumferential edge of the body of said fibrous blank along a direction of extension, the fibrous preform comprising a flange extending from the second circumferential edge of the body of said preform along a direction of expansion different from the direction of extension.

9. A method for manufacturing a fibrous preform intended to form the fibrous reinforcement of a composite material part, the method comprising:
manufacturing a fibrous blank by automated fiber placement on a surface, said fibrous blank comprising a body of partial revolution extending along the circumferential direction around the axial direction, said body extending along the axial direction between a first and a second circumferential edge, said fibrous blank further comprising a flange extending from the second circumferential edge of the body along a direction of extension,
impregnating the fibrous blank with a resin, and
deforming the impregnated fibrous blank to obtain a fibrous preform by implementation of the method of claim 7.
